(19) United States
(12) Patent Application Publication
(10) Pub. No.: US 2008/0151198 A1
(43) Pub. Date: Jun. 26, 2008

(54) System and method for slim projection displays

(75) Inventor: Matthew Glen Hine, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/644,260

(22) Filed: Dec. 22, 2006

(51) Int. Cl. G03B 21/28

(52) U.S. Cl. 353/98

(57) ABSTRACT

System and method for projection displays with shallow cabinet depth. An embodiment comprises receiving parameters for a projection display system, minimizing a space occupied by the projection display system based on the parameters, computing physical parameters of the projection display system, and repeating the minimizing and the computing in response to a determining that the projection display system does not fit inside a cabinet of the projection display system. A setting of a fold mirror and a display plane so that a maximum angle of incidence is substantially equal to a maximum angle of incidence for the display plane and then moving the two together while maintaining optical alignment minimizes the depth of the cabinet of the projection display system.

### TECHNICAL FIELD

The present invention relates generally to a system and method for displaying images, and more particularly to a system and method for projection displays with shallow cabinet depth.

### BACKGROUND

Projection display systems using micro-display technology, such as a digital micromirror device (DMD) based projection display system, provide a low-cost, high-performance alternative to expensive thin flat screen display systems, such as plasma and LCD A projection display system with approximately the same screen size as a flat screen display system may cost a significant amount of money less than the flat screen display system, with the cost advantage increasing with increased screen size. Additionally, projection display systems may have optical advantages over flat screen display systems, such as superior contrast ratios, smoother images, less visible picture elements, and so forth, over flat screen display systems.

However, an advantage of flat screen display systems is their thinness (shallow cabinet depth). A flat screen display system may be as thin as a few inches, while a projection display system's cabinet may be several times thicker. Many consumers may select a flat screen display system over a projection display system, ignoring the projection display system's sometimes significant advantages, based solely on the flat screen display system's thinner profile and its ability to be mounted onto a vertical surface.

In a projection display system, such as a DMD-based projection display system, light from a light source is projected onto an array of light modulators (the DMD), which can, based on image data of an image being displayed, reflect the light away from or onto a display plane. Other micro-display technologies may modulate a light passing through the array of light modulators.

In order to produce an image of desired size, the modulated light in a projection display system must travel a predetermined distance in order to disperse sufficiently to create the properly sized image. The distance that the modulated light must travel may be a function of the optical characteristics of the optical system of the projection display system, such as the focal length of the lenses, desired image size, and so forth. Typically, the greater the distance that the modulated light must travel, the greater the cabinet depth.

### SUMMARY OF THE INVENTION

These and other problems are generally solved or circumvented, and technical advantages are generally achieved, by embodiments of the present invention which provide a system and a method for creating projection display systems with shallow cabinet depth.

In accordance with an embodiment, a method of manufacturing a projection display system is provided. The method includes receiving parameters for the projection display system, minimizing a space occupied by the projection display system based on the parameters, and computing physical parameters of the projection display system. The method also includes repeating the minimizing and the computing in response to a determination that the projection display system does not fit inside a cabinet of the projection display system, installing a projection system, installing a display plane in the light path of the multiple colors of light, the display plane comprising a Fresnel lens and a light magnifying layer, and installing a mirror in the light path between the display plane and the projection system, wherein a top edge of the mirror and a top edge of the display plane are positioned so that an angle formed between light reflecting from the mirror and the display plane is substantially equal to a maximum angle of incidence of the Fresnel lens.

In accordance with another embodiment, a method of manufacturing a display system is provided. The method includes installing a projection system, the installing comprising installing a light source configured to produce multiple colors of light, installing a spatial light modulator in the light path of the multiple colors of light, and installing a projection lens with an optical offset in the light path of the multiple colors of light after the spatial light modulator. The method further includes installing a controller configured to control the light source and the spatial light modulator, installing a display plane in the light path of the multiple colors of light, the display plane comprising a Fresnel lens and a light magnifying layer, and installing a single fold mirror in the light path between the display plane and the projection system, wherein a top edge of the mirror and a top edge of the display plane are positioned so that an angle formed between light reflecting from the mirror and the display plane is substantially equal to a maximum angle of incidence of the Fresnel lens.

In accordance with another embodiment, a projection display system is provided. The projection display system includes a light source, an array of light modulators optically coupled to the light source, the array of light modulators configured to modulate light from the light source based upon received image data to create a projection of an image, and a controller electrically coupled to the array of light modulators and to the light source, the controller configured to provide light commands to the light source and load the image data into the array of light modulators. The projection display system also includes a projection lens with an optical offset, the projection lens optically coupled to the array of light modulators, the projection lens to project the image onto the display plane, a display plane including a Fresnel lens and a light magnifying layer, and a single fold mirror optically coupled to the display plane and to the projection system, the mirror to reflect a projected image from the projection system onto the display plane, wherein a top edge of the mirror and a top edge of the display plane are positioned so that an angle formed between light reflecting from the mirror and the display plane is substantially equal to a maximum angle of incidence of the Fresnel lens.

An advantage of an embodiment is that for a given set of optical properties, such as screen angle of incidence, lens offset, and so forth, a projection display system with optimized cabinet depth may be determined.

A further advantage of an embodiment is that standard projection display system technologies may be used, thereby minimizing implementation costs. This may allow projection display system designers and manufacturers to create thin projection display systems while maintaining a cost advantage over flat screen display systems.

Yet another advantage of an embodiment is that simple optics arrangements are used, which may help to maintain the reliability and performance of the projection display system. For example, it may be possible to create an extremely thin projection display system. However, complicated and expensive optics may be required. This may increase the cost of the projection display system. Additionally, the complex optics design may require frequent calibrations and adjustments to ensure that optimal performance is maintained.

The foregoing has outlined rather broadly the features and technical advantages of embodiments of the present invention in order that the detailed description of the invention that follows may be better understood. Additional features and advantages of embodiments the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a through 1c are diagrams of exemplary projection display systems;

FIG. 2 is a diagram of a projection display system; and

FIG. 3 is a diagram of a sequence of events in the designing of a projection display system.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a DMD-based projection display system. The embodiments may also be applied, however, to other micro-display based projection display systems, such as those utilizing deformable mirrors, transmissive and reflective liquid crystal displays, liquid crystal on silicon, and so forth. Furthermore, the embodiments may be applied to standard projection display systems, such as those using cathode ray tubes (CRT).

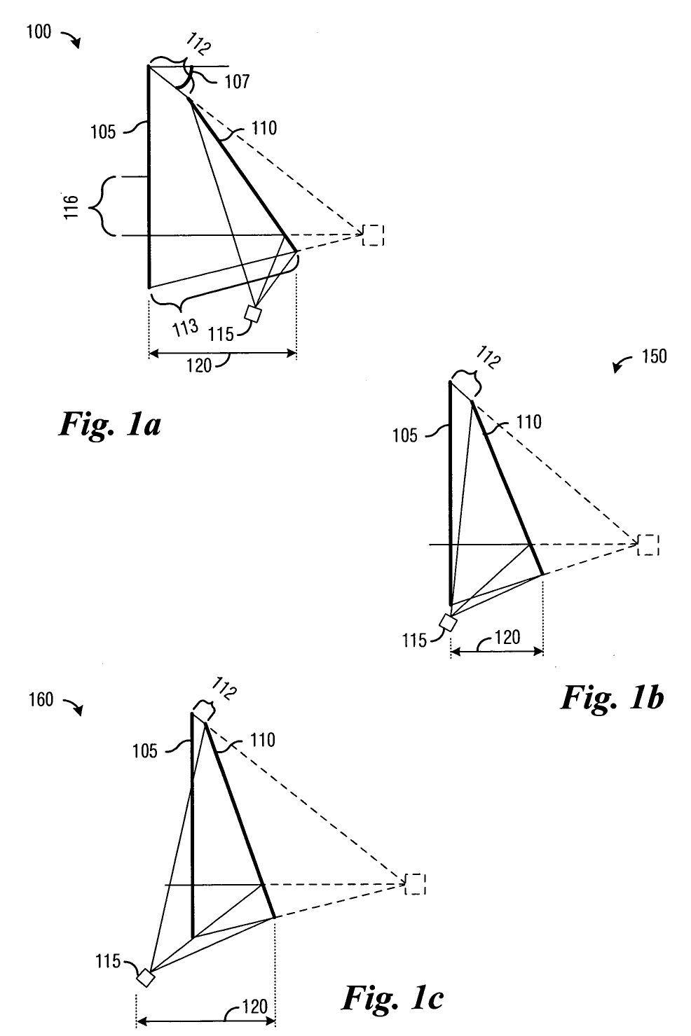

With reference now to FIGS. 1a through 1c, there are shown diagrams illustrating exemplary projection display systems, wherein the projection display systems contain a single fold mirror, a screen, and a projection system containing a projection lens with an offset. A projection display system's physical dimensions (such as its height and depth) can depend on several factors, including but not limited to: the optical properties of the screen, physical properties of the screen, the location of the fold mirror, the optical properties of the projection lens, and so forth.

The diagram shown in FIG. 1a illustrates a projection display system 100 that includes a screen 105, a fold mirror 110, and a projector system 115. According to an embodiment, the screen 105 comprises two layers, a lenticular layer and a Fresnel lens. The Fresnel lens portion of the screen 105 is capable of redirecting light beams incident to the screen 105 within a certain range of angles of incidence and creating substantially parallel light beams, while the lenticular layer collects the light and brightens the image. The angle of incidence of the light beams reflecting from the fold mirror 110 and then striking the screen 105 can vary depending on the location of where the light beam reflects from the fold mirror 110. However, the most acute angle of incidence occurs when light beams reflect from a top edge of the fold mirror 110 and strike the screen 105 at its top edge. This angle of incidence is shown in FIG. 1a as maximum angle 107.

The fold mirror 110 can be positioned behind the screen 105 so that it may reflect light provided by the projection system 115 onto the screen 105. The positioning of the fold mirror 110 can be specified with two distance values, a first distance value (shown as span 112) may specify a separation between a top edge of the fold mirror 110 and a top edge of the screen 105 and a second distance value (shown as span 113) may specify a separation between a bottom edge of the fold mirror 110 and a bottom edge of the screen 105.

The projection system 115 may have a projection lens with an offset, which is generally the difference between an optical center of an image as projected by the projection lens of the projection system 115 and an optical center of the screen 105. The offset is shown in FIG. 1a as a span 116. The offset may be specified as a distance value or as a percentage of the size of the screen 105.

The depth of the projection display system 100 may be defined as a largest horizontal extent between components of the projection display system 100, and is normally a distance between the screen 105 and the furthest extent of the fold mirror 110, shown as span 120. As the fold mirror 110 is brought closer to the screen 105, the smaller the depth of the projection display system 100 becomes. The diagram shown in FIG. 1b illustrates a projection display system 150 with the fold mirror 110 brought forward, closer to the screen 105. However, this may require the Fresnel lens part of the screen 105 to have a larger range of angles of incidence, which can increase the cost of the screen 105. Additionally, as the fold mirror 110 becomes more parallel with the screen 105, the projection system 115 may move towards the front of the projection display system 100 and may eventually move in front of the screen 105, resulting in an increase in the depth of the projection display system 100. The diagram shown in FIG. 1c illustrates a projection display system 160 with the fold mirror 110 moved too close to the screen 105 so that the projection system 115 is, by necessity, moved forward of the screen 105.

In U.S. Pat. No. 6,857,750, entitled “Offset Projection for Slim Rear Projection Displays,” issued Feb. 22, 2005, which is incorporated herein by reference, a projection display system with a fold mirror, a screen, and a projection system, which may include a projection lens with an optical offset, is described. In U.S. Pat. No. 5,048,949, entitled “Liquid Crystal Projector,” issued Sep. 17, 1991, which is incorporated herein by reference, a projection display system with two fold mirrors, a screen, and a projection system is described. The use of two fold mirrors may allow for a further reduction in the overall depth of the projection display system by twice overlapping the distance traveled by the projected light.

The optical offset of the projection lens, along with optical properties of the screen, may be used to adjust the overall cabinet depth of the projection display system. According to embodiments, the optical properties of the screen, such as a maximum angle of incidence of a Fresnel lens of a typical display system screen, may be utilized to set a position of the fold mirror 110, while the optical offset of the projection lens may be used to permit the positioning of a projection system of the projection display system. The combination of the two may result in a projection display system that is thinner overall than the prior art projection display systems described in the U.S. Pat. Nos. 6,857,750 and 5,048,949, with less cost and greater reliability.

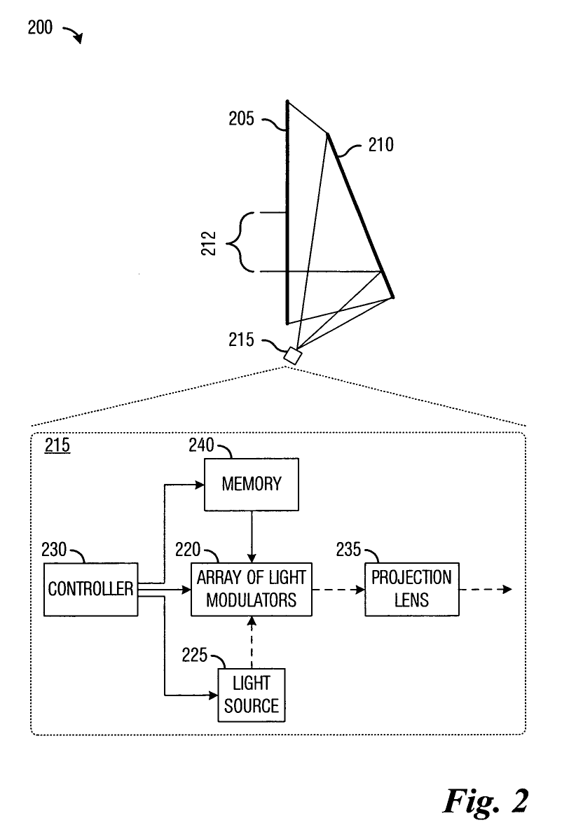

With reference now to FIG. 2, there is shown a diagram illustrating an exemplary projection display system 200. The projection display system 200 includes a display plane 205, a fold mirror 210, and a projection system 215. The display plane 205 may be a composite screen made up of more than one component, including a Fresnel lens portion and a lenticular layer. The fold mirror 210 reflects projected light from the projection system 215 onto the display plane 205. The fold mirror 210 allows for a reduction in the depth of the projection display system 200 by folding the projected light over onto itself, thereby reducing the extent of the physical size of path traversed by the light but maintaining the same light path length.

The projection system 215 may be used to provide the projected light that is displayed on the display plane 205. The projection system 215 may utilize image data of images to be displayed to control an array of light modulators 220, for example, a DMD, to modulate light produced by a light source 225, which when used with an integrator produces collimated light, with each light modulator in the array of light modulators 220 being controllable by commands provided by a controller 230. The controller 230 may utilize a memory 240 to store image data as well as control and configuration information. The light modulated by the array of light modulators 220 as displayed on the display plane 205 may be visually integrated by the human eye into images.

The projection system 215 can include a projection lens 235 with an optical offset 212. In some situations, the projection lens 235 may comprise more than one lens. The position of the fold mirror 210 and the projection system 215 may be dependent on factors such as optical properties of the display plane 205 and the lens(es) in the projection system 215, for example, the range of angles of incidence of the Fresnel lens of the display plane 205, the focal length of the lens(es) in the projection system 215, as well as any offset present in the lens(es). Furthermore, the desired image size of the images on the display plane 205 can have an effect on the position of the fold lens 210 and the projection system 215, hence, the depth of the projection display system 200.

Typically, the cost of a display plane containing a Fresnel lens may be dependent on the range of angles of incidence of the Fresnel lens. The angle of incidence of a display system is also the field half angle of the projection lens. For example, a minimum cost display plane may be achieved with a Fresnel lens with a relatively low maximum angle of incidence, such as lenses with a range of angles of incidence from about 0 to about 56 degrees or from about 0 to about 62 degrees. If a greater maximum angle of incidence is required, then the required Fresnel lens may be more expensive. Correspondingly, the display plane becomes more expensive, as does the projection display system. Therefore, there is a desire to create a minimum cost by utilizing the least costly components as possible and minimizing the depth of the projection display system's cabinet. Although the above specifies a range of maximum angles of incidence for a Fresnel lens, a Fresnel lens with any maximum angle of incidence may be used with the present invention.

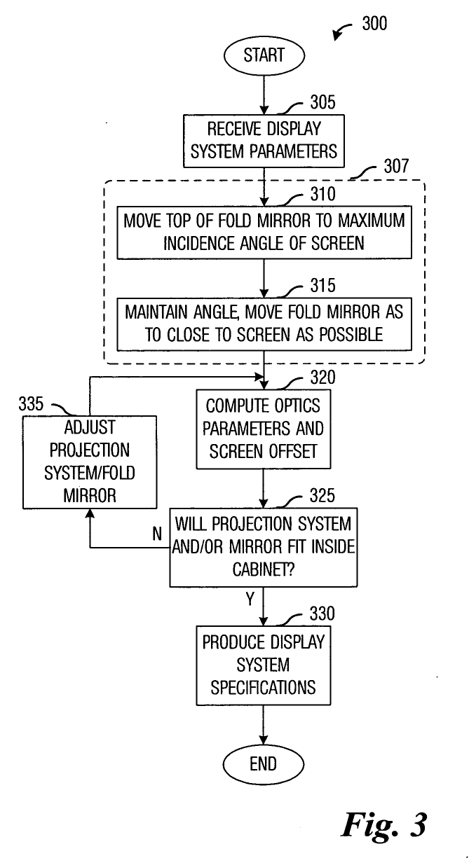

With reference now to FIG. 3, there is shown a diagram illustrating a sequence of events 300 in the designing of a projection display system, given a set of display system parameters and component characteristics. The designing of the projection display system can begin with the receiving of a set of display system parameters, along with component characteristics (block 305). Display system parameters may include screen size, target display system cost, display resolution, and so forth, while component characteristics may include display screen range of angles of incidence, optical offset for lens(es) in projection system, size of projection system, and so forth.

Using the display screen's range of angles incidence, it may now be possible minimize the size of the projection display system (block 307). The size of projection display system may be described as the size of a cabinet used to house the projection display system, with the depth of the cabinet being an important dimension to minimize. The minimization can make use of the display system parameters along with the component characteristics.

In one embodiment, to minimize the size of the projection display system, it may be necessary to set the position of the fold mirror of the projection display system (block 310). In a projection display system with a single fold mirror, a light beam's most acute angle of incidence with the display screen occurs at a top edge of the fold mirror and a top edge of the display screen. Therefore, using a maximum angle of incidence of the Fresnel lens of the display screen, it may be possible to fix the location of the top edge of the fold mirror in relation to the display screen. The top edge of the fold mirror and the top edge of the display screen should be positioned so that the angle of incidence may not exceed the maximum angle of incidence of the Fresnel lens. While maintaining the angle of incidence, the fold mirror may be moved as close to the display screen as possible (block 315). In bringing the fold mirror to the display screen, optical alignment should be maintained.

A verification of the positioning of the fold mirror and the projection system may be performed by executing a parametric computer model of the projection display system (block 320). The parametric computer model may be provide necessary information, such as screen size, display resolution, and so forth, and component characteristics may include display screen range of angles of incidence, optical offset for lens(es) in projection system, size of projection system, and so forth. The computer model may then simulate the operation of the projection display system to verify proper function.

Several checks may be made of the projection display system, including but not limited to checking to determine if the projection system and/or the fold mirror will fit inside a display system cabinet of choice (block 325). If the projection system will not fit inside the display system cabinet, it may be possible to make adjustments to the projection system to reduce the display system's size (block 335). With the fold mirror's position in relation to the display screen set, the projection system of the projection display system may be positioned so that the images project properly onto the display screen, with the projection system being placed as close to the front of the projection display system as possible. The adjustment of the position of the projection system may be performed so that an image projected by the projection system will properly display on the display plane. The adjustment of the position of the projection system may also include tweaking the components in the projection system to alter the size of the projection system. If the fold mirror will not fit inside the display system cabinet, it may be necessary to adjust the projection system to permit adjustments to the fold mirror while maintaining compliance to the display system parameters and component characteristics. It may be possible to utilize a more detailed model and/or engineering design tool to automatically check the fit of the projection system/fold mirror and the display system cabinet. Once the projection system does fit into the display system cabinet (as verified through the use of the parametric model (block 320)), it may be possible to begin production of the projection display system using specifications of the projection display system (block 330).

Using the above described sequence of events 300 for designing a projection system, a display plane with a Fresnel lens with a maximum angle of incidence ranging from about 56 degrees to about 62 degrees, and a projection lens with an optical offset ranging from about 50 percent to about 70 percent, computed cabinet depths range from about 10 inches for an image size of 44 inches to about 14 inches for an image size of about 62 inches.

Although the embodiments and their advantages have been described in detail, it should be understood that various changes, substitutions and alterations may be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein can be utilized according to the present invention. Accordingly, the appended claims are intended to include within their scope such processes, machines, manufacture, compositions of matter, means, methods, or steps.

What is claimed is:

1. A method of manufacturing a projection display system, the method comprising:
receiving parameters for the projection display system;
minimizing a space occupied by the projection display system based on the parameters;
computing physical parameters of the projection display system;
repeating the minimizing and the computing in response to a determination that the projection display system does not fit inside a cabinet of the projection display system;
installing a projection system;
installing a display plane in the light path of the multiple colors of light, the display plane comprising a Fresnel lens and a light magnifying layer; and
installing a mirror in the light path between the display plane and the projection system, wherein a top edge of the mirror and a top edge of the display plane are positioned so that an angle formed between light reflecting from the mirror and the display plane is substantially equal to a maximum angle of incidence of the Fresnel lens.

2. The method of claim 1, wherein the space comprises a footprint of the projection display system.

3. The method of claim 1, wherein the space comprises a footprint of a display plane and a fold mirror.

4. The method of claim 1, wherein the minimizing comprises locating a top edge of a fold mirror along a top edge of a display plane, wherein an angle formed between light reflecting from the fold mirror and the display plane is substantially equal to a maximum angle of incidence of the display plane.

5. The method of claim 4, wherein the minimizing further comprises adjusting a position of a projection system of the projection display system in response to the determination that the projection display system does not fit inside a cabinet of the projection display system.

6. The method of claim 4, wherein the minimizing further comprises, after the locating, moving the fold mirror towards the display plane, wherein the angle formed between the fold mirror and the display plane is substantially maintained.

7. The method of claim 6, wherein the fold mirror is moved towards the display plane while maintaining optical alignment.

8. The method of claim 4, wherein the projection system is positioned as close to a bottom edge of the display plane without contacting the display plane.

9. The method of claim 4, wherein the repeating comprises repeating the adjusting and the computing.

10. The method of claim 4, wherein the adjusting of the position of the projection system comprises moving the projection system to properly project an image produced by the projection system on the display plane.

11. The method of claim 1, wherein the repeating comprises adjusting a projection system prior to repeating the minimizing and the computing.

12. The method of claim 11, wherein the repeating further comprises adjusting a fold mirror in response to adjustments made to the projection system.

13. A method of manufacturing a display system, the method comprising:
installing a projection system, the installing comprising,
installing a light source configured to produce multiple colors of light;
installing a spatial light modulator in the light path of the multiple colors of light;
installing a projection lens with an optical offset in the light path of the multiple colors of light after the spatial light modulator;
installing a controller configured to control the light source and the spatial light modulator;
installing a display plane in the light path of the multiple colors of light, the display plane comprising a Fresnel lens and a light magnifying layer; and
installing a single fold mirror in the light path between the display plane and the projection system, wherein a top edge of the mirror and a top edge of the display plane are positioned so that an angle formed between light reflecting from the mirror and the display plane is substantially equal to a maximum angle of incidence of the Fresnel lens.

14. The method of claim 13, wherein the projection system is installed beneath and behind the display plane.

15. The method of claim 13, wherein the mirror is placed with minimal separation between the mirror and the display plane while maintaining optical alignment.

16. The method of claim 13, wherein the installing of the mirror comprises setting a bottom edge of the mirror so that the multiple colors of light reflecting from the mirror strike the Fresnel lens within a permitted range of angles of incidence of the Fresnel lens.

17. A projection display system comprising:
a projection system, the projection system comprising,
a light source;
an array of light modulators optically coupled to the light source, the array of light modulators configured to modulate light from the light source based upon received image data to create a projection of an image;
a controller electrically coupled to the array of light modulators and to the light source, the controller configured to provide light commands to the light source and load the image data into the array of light modulators;
a projection lens with an optical offset, the projection lens optically coupled to the array of light modulators, the projection lens to project the image onto the display plane;
a display plane including a Fresnel lens and a light magnifying layer; and
a single fold mirror optically coupled to the display plane and to the projection system, the mirror to reflect a projected image from the projection system onto the display plane, wherein a top edge of the mirror and a top edge of the display plane are positioned so that an angle formed between light reflecting from the mirror and the display plane is substantially equal to a maximum angle of incidence of the Fresnel lens.

18. The projection display system of claim 17, wherein the light magnifying layer is a lenticular lens.

19. The projection display system of claim 17, wherein the projection display system is enclosed in a cabinet, wherein the Fresnel lens has a maximum angle of incidence from about 56 degrees to 62 degrees, wherein the projection lens has an optical offset ranging from about 50 to about 70 percent, and wherein the cabinet ranges in depth from about 10 to 14 inches.

20. The projection display system of claim 17, wherein the array of light modulators is a spatial light modulator.

21. The projection display system of claim 20, wherein the spatial light modulator is a digital micromirror device.
